(19) United States
(12) Patent Application Publication
(10) Pub. No.: US 2004/0075863 A1
(43) Pub. Date: Apr. 22, 2004

(54) Image-forming system and routing method for the same

(75) Inventors: Tomohiro Suzuki, Tokyo (JP); Yuji Tamura, Tokyo (JP); Tetsuya Ishikawa, Tokyo (JP); Tadashi Sumi, Tokyo (JP); Tomoya Ogawa, Tokyo (JP); Fumikage Uchida, Asaka-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/682,211

(22) Filed: Oct. 8, 2003

(30) Foreign Application Priority Data
Oct. 16, 2002 (JP) JP2002-301276

(51) Int. Cl. G06F 3/05; G06F 3/12; G06F 15/00

(52) U.S. Cl. 358/1.15

(57) ABSTRACT

There is described a network system for processing image data. The network system includes an image-processing apparatus including an image-reading section to read an image from a document; an image-printing apparatus including an image-printing section to print an image on a sheet; a plurality of networks including a first network and a second network; and a plurality of information processing apparatus including a first information processing apparatus coupled to the first network and a second information processing apparatus coupled to the second network. The image-processing apparatus or the image-printing apparatus further includes: a routing section to conduct a routing operation between the first information processing apparatus and the second information processing apparatus. The image-processing apparatus further includes: a first network I/F section, through which the image-processing apparatus is coupled to the first network; and a second network I/F section, through which the image-processing apparatus is coupled to the second network.

### BACKGROUND OF THE INVENTION

The present invention relates to an image-processing apparatus and an image-processing system, and specifically relates to an image-processing apparatus having an image-recording means and an image-processing system constituted by coupling the image-processing apparatus, an image-printing apparatus, an information processing apparatus, etc. to each other in a network.

Conventionally, there has been well known an image-processing apparatus, such as a scanner, etc., that is provided with an image-reading means for acquiring scanner data by reading an image from a document on which the image is recorded and an image-processing means for applying various kinds of image-processing operations to the scanner data.

Further, there has been well known an image-processing system in a network environment, in which the image-printing apparatus, such as a printer, etc., and an information processing apparatus such as a personal computer, etc., are coupled to each other so as to communicate with each other by coupling the image-processing apparatus to the network, like the network scanner.

Still further, for this kind of network system, it has been desired to construct a system having higher utility values by coupling the network to a plurality of other network systems.

For instance, according to “PRINTING SYSTEM AND COMMUNICATION METHOD OF THE SAME” set forth in Patent Document 1 (listed later), a plurality of connecting means are equipped in the apparatus, in order to couple a plurality of host computers and a plurality of printing apparatus to each other through a plurality of networks. Further, by organically connecting (possibly including wave-shaping, amplifying operations) them to each other and by realizing a repeater function, the system makes it possible to eliminate a necessity of a special connecting apparatus, such as repeater, etc., to be equipped as an external device. Further, the apparatus conducts a print processing by itself while analyzing the commands on the network through the connecting section.

Further, according to “PRINTING APPARATUS, PRINTING SYSTEM, INFORMATION PROCESSING APPARATUS AND PRINTING METHOD” set forth in Patent Document 2 (listed later), two pairs of connecting sections are equipped in the printing apparatus, in order to couple a plurality of host computers and a plurality of printing apparatus to each other in a mode of the network-chain connection. Further, the function of determining whether or not connecting the two network and the function of really connecting them are provided in the system. The judgment of the function is determined in advance according to the commands before and after the printing apparatus. Further, the apparatus conducts a print processing by itself while analyzing the commands on the network through the connecting section.

Still further, according to “IMAGE-PROCESSING SYSTEM, JOB TRANSMITTING METHOD, INFORMATION PROCESSING APPARATUS AND RECORDING MEDIUM” set forth in Patent Document 3 (listed later), a rasterizing function is provided in the system, in order to conduct print processing operations in a plurality of image-forming apparatus according to the commands sent from a client's computer. By being provided with a first network, serving as a public network, for connecting with the client's computer, and a second network, serving as a private network, for connecting with a plurality of image-forming apparatus, the first network and the second network are separated form each other and the communication traffics on the second network would be alleviated. As a result, it becomes possible to construct a high-performance image-forming system.

Patent document 1: Tokkaihei 7-334328

Patent document 2: Tokkaihei 8-137641

Patent document 3: Tokkai 2001-134390

The conventional technologies mentioned above, however, have included the problems described as follow.

With respect to “PRINTING SYSTEM AND COMMUNICATION METHOD OF THE SAME” set forth in Patent Document 1, since there is no restricting means for restricting information transmission, there has been a problem that it is impossible to attach a restriction to the information transmitting in each of a plurality of networks or between a network and another network.

Further, with respect to “PRINTING APPARATUS, PRINTING SYSTEM, INFORMATION PROCESSING APPARATUS AND PRINTING METHOD” set forth in Patent Document 2, although the restricting means for restricting information transmission is provided in the system, the restricting means is such a means that switches whether or not the information should be transmitted between the private network and the public network, based on the result of the negotiation performed in advance by means of the bilateral communicating operations between them. Accordingly, there has been a problem that it is impossible to restrict the information transmission, depending on the contents of the information to be transmitted.

Still further, “IMAGE-PROCESSING SYSTEM, JOB TRANSMITTING METHOD, INFORMATION PROCESSING APPARATUS AND RECORDING MEDIUM”, set forth in Patent Document 3, relates to a system for controlling a plurality of printing apparatus by means of a single rasterizer. Since an amount of data transmitted between the rasterizer and the printing apparatus becomes enormous, the public network is separated and the private network is constructed so as to alleviate the deterioration of the network traffics. Accordingly, it is not considered to introduce the client's computer in the private network side, and further, a managing function in view of how to couple the private network and the public network to each other is not provided, and furthermore, there are no considerations for the security aspect of the data.

### SUMMARY OF THE INVENTION

To overcome the abovementioned drawbacks in conventional network systems, it is an object of the present invention to provide an image-processing system, in which a security aspect between networks can be improved, while utilizing a network environment of coupling to a plurality of networks.

Accordingly, to overcome the cited shortcomings, the abovementioned object of the present invention can be attained by network systems described as follow.

(1) A network system for processing image data, comprising: an image-processing apparatus including an image-reading section to read an image from a document; an image-printing apparatus including an image-printing section to print an image on a sheet; a plurality of networks including a first network and a second network; and a plurality of information processing apparatus including a first information processing apparatus coupled to the first network and a second information processing apparatus coupled to the second network; wherein the image-processing apparatus further includes: a routing section to conduct a routing operation between the first information processing apparatus and the second information processing apparatus.

(2) The network system of item 1, wherein the image-processing apparatus further includes: a first network I/F section, through which the image-processing apparatus is coupled to the first network; and a second network I/F section, through which the image-processing apparatus is coupled to the second network.

(3) The network system of item 1, wherein the image-printing apparatus is coupled to either the image-processing apparatus or anyone of the plurality of networks.

(4) The network system of item 1, wherein the image-processing apparatus and the image-printing apparatus are integrated into a single apparatus; and wherein the single apparatus is coupled to both the first network and the second network.

(5) The network system of item 4, wherein the single apparatus is a digital copier.

(6) The network system of item 1, wherein the plurality of information processing apparatus includes a computer or a personal computer.

(7) A network system for processing image data, comprising: an image-processing apparatus including an image-reading section to read an image from a document; an image-printing apparatus including an image-printing section to print an image on a sheet; a plurality of networks including a first network and a second network; and a plurality of information processing apparatus including a first information processing apparatus coupled to the first network and a second information processing apparatus coupled to the second network; wherein the image-printing apparatus further includes: a routing section to conduct a routing operation between the first information processing apparatus and the second information processing apparatus.

(8) The network system of item 7, wherein the image-printing apparatus further includes: a first network I/F section, through which the image-printing apparatus is coupled to the first network; and a second network I/F section, through which the image-printing apparatus is coupled to the second network.

(9) The network system of item 7, wherein the image-processing apparatus is coupled to either the image-printing apparatus or anyone of the plurality of networks.

(10) The network system of item 7, wherein the image-processing apparatus and the image-printing apparatus are integrated into a single apparatus; and wherein the single apparatus is coupled to both the first network and the second network.

(11) The network system of item 10, wherein the single apparatus is a digital copier.

(12) The network system of item 7, wherein the plurality of information processing apparatus includes a computer or a personal computer.

(13) A network system for processing image data, comprising: an image-processing apparatus including an image-reading section to read an image from a document; an image-printing apparatus including an image-printing section to print an image on a sheet; and an information processing apparatus coupled to both the image-processing apparatus and the image-printing apparatus through a network; wherein the image-processing apparatus or the image-printing apparatus further includes: a provided function setting section to set a functional restriction for restricting a function to be provided for the information processing apparatus.

(14) The network system of item 13, wherein the image-processing apparatus and the image-printing apparatus are integrated into a single apparatus; and wherein the single apparatus includes the provided function setting section.

(15) The network system of item 14, wherein the single apparatus is a digital copier.

(16) The network system of item 13, wherein the information processing apparatus is a computer or a personal computer.

(17) A network system for processing image data, comprising: an image-processing apparatus including an image-reading section to read an image from a document; an image-printing apparatus including an image-printing section to print an image on a sheet; and an information processing apparatus coupled to both the image-processing apparatus and the image-printing apparatus through a network; wherein the image-processing apparatus or the image-printing apparatus further includes: a server section that serves as a server for apparatus on the network.

(18) The network system of item 17, wherein the image-processing apparatus and the image-printing apparatus are integrated into a single apparatus; and wherein the single apparatus is a digital copier including the server section.

(19) The network system of item 17, wherein the information processing apparatus is a computer or a personal computer.

(20) The network system of item 17, wherein the server section is anyone of a web server, a mail server and a database server.

Further, to overcome the abovementioned problems, other image-processing systems, embodied in the present invention, will be described as follow:

(21) An image-processing system, characterized in that,

in the image-processing system, which includes an image-processing apparatus having an image-reading means for reading an image from a document, an image-printing apparatus having an image-printing means for printing an image on a sheet, and information processing apparatus, the image-processing apparatus further has first network I/F means for connecting to a first network, second network I/F means for connecting to a second network, and a routing means for conducting a routing between an information processing apparatus coupled to the first network and an information processing apparatus coupled to the second network.

(22) An image-processing system, characterized in that,

in the image-processing system, which includes an image-processing apparatus having an image-reading means for reading an image from a document, an image-printing apparatus having an image-printing means for printing an image on a sheet, and information processing apparatus,

the image-printing apparatus further has a first network I/F means for connecting to a first network, a second network I/F means for connecting to a second network, and a routing means for conducting a routing between an information processing apparatus coupled to the first network and an information processing apparatus coupled to the second network.

(23) An image-processing system, characterized in that,

in the image-processing system, that is so constituted that an image-processing apparatus, having an image-reading means for reading an image from a document, an image-printing apparatus, having an image-printing means for printing an image on a sheet, and information processing apparatus are coupled to each other through a network,

the image-processing apparatus further has a provided function setting means for setting a restriction of function to be provided for the information processing apparatus.

(24) An image-processing system, characterized in that,

in the image-processing system, that is so constituted that an image-processing apparatus, having an image-reading means for reading an image from a document, an image-printing apparatus, having an image-printing means for printing an image on a sheet, and information processing apparatus are coupled to each other through a network,

the image-printing apparatus further has a provided function setting means for setting a restriction of function to be provided for the information processing apparatus.

(25) An image-processing system, characterized in that,

in the image-processing system, that is so constituted that an image-processing apparatus, having an image-reading means for reading an image from a document, an image-printing apparatus, having an image-printing means for printing an image on a sheet, and information processing apparatus are coupled to each other through a network, the image-processing apparatus further has a server means for serving as a server for apparatus coupled to the network.

(26) An image-processing system, characterized in that,

in the image-processing system, that is so constituted that an image-processing apparatus, having an image-reading means for reading an image from a document, an image-printing apparatus, having an image-printing means for printing an image on a sheet, and information processing apparatus are coupled to each other through a network,

the image-printing apparatus further has a server means for serving as a server for apparatus coupled to the network.

(27) The image-processing system, described in item 25 or 26, characterized in that

the server means is anyone of a web server, a mail server and a database server.

### BRIEF DESCRIPTION OF THE DRAWINGS

Other objects and advantages of the present invention will become apparent upon reading the following detailed description and upon reference to the drawings in which:

FIG. 1 shows a block diagram of a configuration of an image-processing system, embodied in the present invention;

FIG. 2 shows a block diagram of the configuration of image-processing apparatus 1 shown in FIG. 1;

FIG. 3 shows a block diagram of the configuration of image-printing apparatus 2 shown in FIG. 1;

FIG. 4 shows an example of a setting table with respect to a routing operation in image-processing apparatus 1 shown in FIG. 1;

FIG. 5 shows an example of a setting table with respect to functional restrictions in image-processing apparatus 1 shown in FIG. 1;

FIG. 6 shows a block diagram of a configuration of the image-processing system, as a second embodiment of the present invention;

FIG. 7 shows a block diagram of a configuration of the image-processing system, as a third embodiment of the present invention;

FIG. 8 shows a block diagram of a configuration of the image-processing system, as a fourth embodiment of the present invention;

FIG. 9 shows a block diagram of a configuration of the image-processing system, as a fifth embodiment of the present invention; and

FIG. 10 shows a block diagram of a configuration of the image-processing system, as a sixth embodiment of the present invention.

### DETAILED DESCRIPTION OF THE PREFERRED EMBODIMENT

Referring to the drawings, the preferred embodiment of the present invention will be detailed in the following.

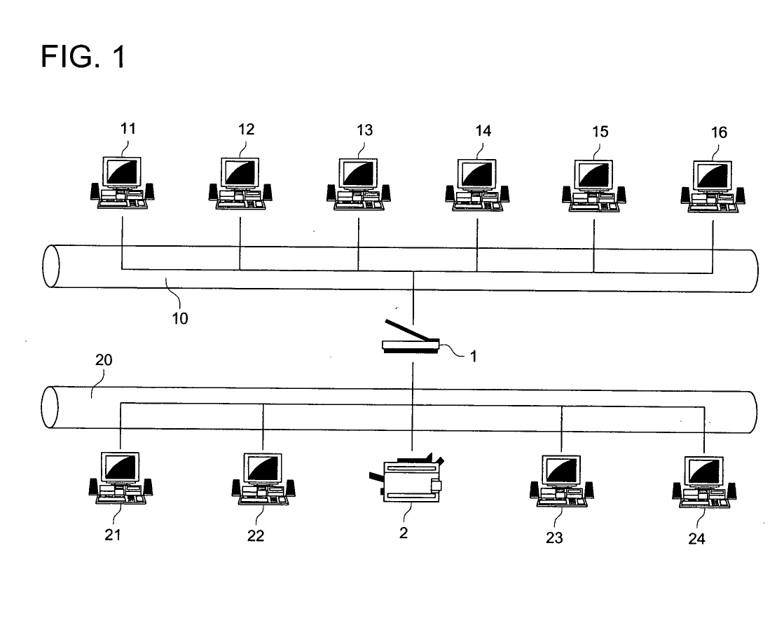

FIG. 1 shows block diagram of a configuration of the image-processing system, embodied in the present invention.

As shown in FIG. 1, the image-processing system, embodied in the present invention, comprises image-processing apparatus 1, image-printing apparatus 2 and information-processing apparatus 11-16 and 21-24. The system is so constituted that image-processing apparatus 1 is coupled to information-processing apparatus 11-16 through network 10, and image-processing apparatus 1 and image-printing apparatus 2 are coupled to information-processing apparatus 21-24 through network 20.

Now, two kinds of network concepts will be introduced, namely, one is a private network being an internally closed network, and another is a public network to which a range wider than that of the private network is coupled. In the embodiment shown in FIG. 1, network 20 is established as the private network, while network 10 is established as the public network. The private network is established in the closed area, for instance, such as a visitor room, a conference room, etc. Further, in the embodiment of the present invention, image-printing apparatus 2 is equipped on the private network.

In the embodiment of the present invention, the information-processing apparatus for a manager of the system is coupled to network 10 serving as a public network. For instance, personal computers can be utilized for information-processing apparatus 11-16 and 21-24.

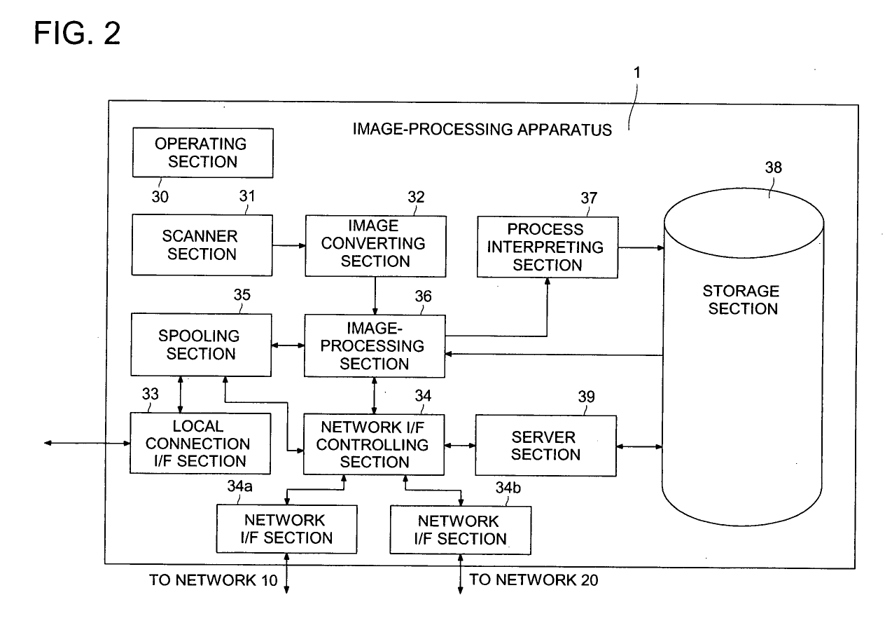

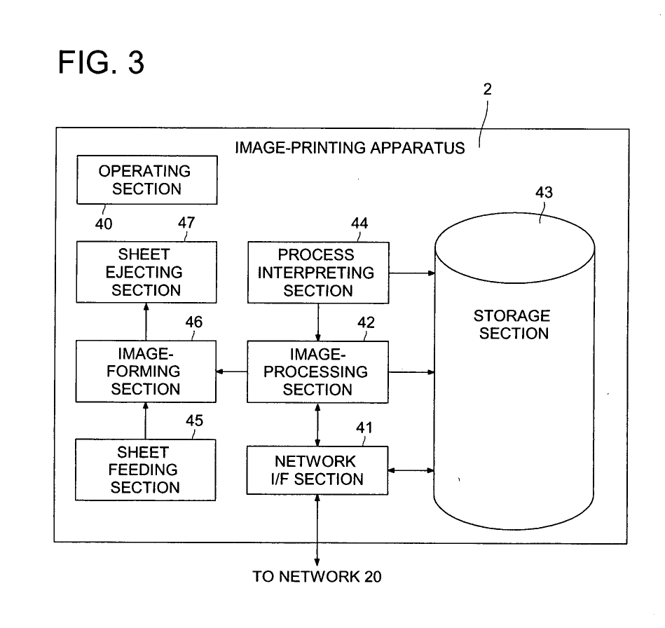

As shown in FIG. 2 detailed later, image-processing apparatus 1 includes scanner section 31 serving as an image-reading means for reading an image from the document, on which the image is recorded, so as to output scanner data, while, as shown in FIG. 3 detailed later, image-printing apparatus 2 includes image-forming section 46 serving as an image-printing means for forming an image on a sheet. It is possible to integrate image-processing apparatus 1 and image-printing apparatus 2 into a single apparatus for practical use, and in this case, it is possible for the single apparatus to realize functions as an image-forming apparatus, such as a digital copier, etc.

FIG. 2 shows a block diagram of the configuration of image-processing apparatus 1 shown in FIG. 1.

As shown in FIG. 2, the configuration of image-processing apparatus 1 includes: operating section 30 that displays information for the user and from which the user inputs operation commands; scanner section 31 that outputs the scanner data by reading an image from the document; image converting section 32 that converts the scanner data outputted from scanner section 31 to PDL data; local connection I/F section 33 serving as an interface for a local connecting line (not shown in the drawings); network I/F controlling section 34 that controls interfaces for the public network and the private network; network I/F section 34a serving as a first network I/F means being an interface for network 10; network I/F section 34b serving as a second network I/F means being an interface for network 20; spooling section 35 that temporarily stores the PDL data inputted through local connection I/F section 33, network I/F section 34a and network I/F section 34b; image-processing section 36 that rasterizes the PDL data sent from image converting section 32 and spooling section 35, and further converts the rasterized data to PDF data; process interpreting section 37 that interprets process information attached to the PDF data outputted from image-processing section 36; storage section 38 that stores data sent from process interpreting section 37; and server section 39 that serves as a server of the network system. Server section 39 is provided with functions of a database server, a mail server and a web server.

Image-processing section 36 of image-processing apparatus 1 has a function of the rasterizer for rasterizing the image data so as to acquire a raster image. Incidentally, although, in the embodiment of the present invention, the rasterized raster image is converted to the PDF data in image-processing section 36, the present invention is not limited to the PDF data, it is also applicable to convert to data of a certain general-purpose image format. Other than the PDF data, the post script, TIFF, etc. can be cited as the general-purpose image format, and any kind of data format disclosed in the public would be applicable for the present invention.

Next, the operations of process interpreting section 37 will be detailed in the following.

When the image data is inputted from scanner section 31, the user (hereinafter, also referred to as the operator) can input contents of the process to be applied to the image data for its printing operation. Then, the inputted process information are attached to the image data, and inputted into process interpreting section 37. Further, the PDL data, inputted through local connection I/F section 33, network I/F section 34a or network I/F section 34b, also includes the contents of the process to be applied to the image data, and then, the process information attached to the image data are inputted into process interpreting section 37 as well.

The process information, namely the contents of the process to be applied to the image data, include such information as, for instance, a page number to be printed in the printing operation, a number of copies to be printed, whether or not the printed sheet is punched, whether or not the printed sheets are stapled, whether or not a plurality of images are allotted in a layout within one sheet in the printing operation, etc.

In process interpreting section 37, the image data (PDF data in this embodiment) are stored in storage section 38 as an image file, and the process information are stored in storage section 38 as a processing file. Incidentally, hereinafter, such a combination of the image file and the processing file is defined as a printing JOB.

Incidentally, although, in the embodiment of the present invention, image-processing section 36 converts the PDL data to the data of the general-purpose image format (the PDF data) after image converting section 32 temporarily converts the scanner data outputted from scanner section 31 to the PDL data, the present invention is not limited to the above procedure, it is also applicable to directly convert the scanner data to the data of the general-purpose image format (the PDF data) without temporarily converting to the PDL data.

FIG. 3 shows a block diagram of the configuration of image-printing apparatus 2 shown in FIG. 1.

As shown in FIG. 3, the configuration of image-printing apparatus 2 includes: operating section 40 that displays information for the user and from which the user inputs operation commands; network I/F section 41 serving as an interface for network 20; image-processing section 42 that makes the image file and the processing file inputted through network I/F section 41 stored into storage section 43; storage section 43 that stores the image file and the processing file; process interpreting section 44 that readouts the processing file from storage section 43 to interpret the contents of the processing file; sheet feeding section 45 that feeds a sheet on which the image is formed; image-forming section 46 that forms the image on the sheet; and sheet ejecting section 47 that ejects the sheet having the image formed by image-forming section 46.

Considering a layout of the images, etc., image-processing section 42 generates an image to be practically formed on the sheet based on the image data outputted from process interpreting section 44, and then, image-forming section 46 forms the image on the sheet.

Since image-printing apparatus 2 handles the data of the general-purpose image format (the PDF data in this embodiment) only when such the data are inputted, and need not to copes with data of another type, such as the PDL data, etc., it is possible to save the cost for handling the data of the other type, resulting in a cost-reduction of the apparatus.

In the image-processing system embodied in the present invention, image-processing apparatus 1 can conduct an access restricting operation while conducting a routing operation (namely, a gateway function). Such a first embodiment will be detailed in the following.

In the first embodiment, information-processing apparatus 11 is defined as a terminal device of a system manager, information-processing apparatus 12 is defined as a proxy server, and each of information-processing apparatus 13-16 and 21-24 is defined as either a client personal computer or a server personal computer.

The system manager sets the access restriction with respect to the routing operation in image-processing apparatus 1. At this time, it is possible to conduct the setting operation not only from, for instance, information-processing apparatus 11 through network 10, but also by using operating section 30 of image-processing apparatus 1. In addition, it is also applicable that the system is so constituted that the setting operation can be conducted when the system manager logons the system with the password registered in advance. Further, it is also applicable that the system is so constituted that the storage section provided in either network 10 or network 20 stores the setting data with respect to the routing operation in advance, and image-processing apparatus 1 voluntarily accesses the storage section to acquire the setting data and sets them in itself.

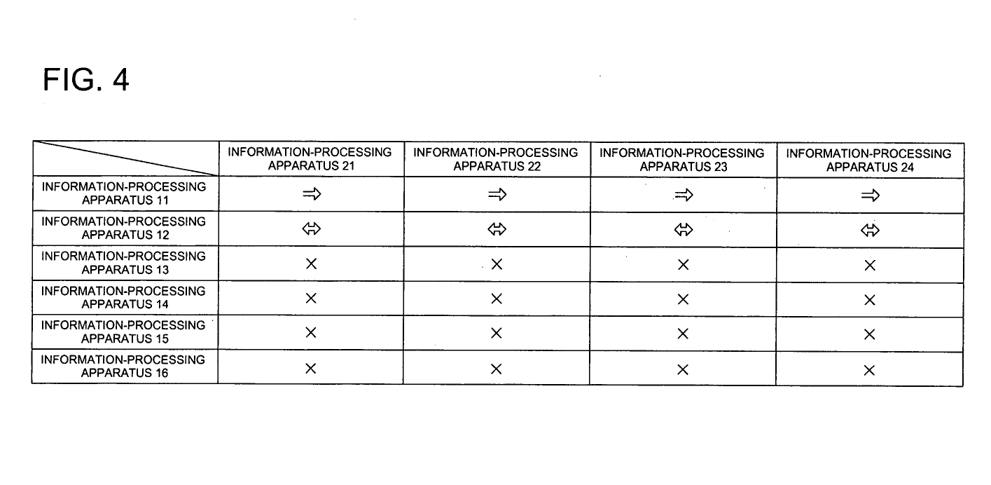

FIG. 4 shows an example of a setting table with respect to the routing operation in image-processing apparatus 1 shown in FIG. 1.

The setting table with respect to the routing operation is utilized for communicating operations between information-processing apparatus 11-16 coupled to network 10 and information-processing apparatus 21-24 coupled to network 20, namely, utilized for routing operations between the public network and the private network.

According to the example shown in FIG. 4, the unilateral communications conducted in the direction from information-processing apparatus 11 to information-processing apparatus 21-24 are allowed, but those in the reverse direction are not allowed. Further, the bilateral communications conducted between information-processing apparatus 12 and information-processing apparatus 21-24 are allowed (since information-processing apparatus 12 is the proxy server), while the bilateral communications conducted between information-processing apparatus 13-16 and information-processing apparatus 21-24 are not allowed.

Network I/F controlling section 34 conducts the routing operations between the public network and the private network according to the access restricting conditions shown in FIG. 4 as an example. This is the routing means.

Next, the image-processing system embodied in the present invention can conduct a restricting operation (a functional restriction) when an apparatus coupled to either network 10 or network 20 utilizes a function of image-processing apparatus 1. Such a second embodiment will be detailed in the following.

In the second embodiment, information-processing apparatus 11 is defined as a terminal device of a system manager, and each of information-processing apparatus 12-16 and 21-24 is defined as either a client personal computer or a server personal computer.

The system manager sets the access restriction with respect to the routing operation in image-processing apparatus 1. At this time, it is possible to conduct the setting operation not only from, for instance, information-processing apparatus 11 through network 10, but also by using operating section 30 of image-processing apparatus 1. In addition, it is also applicable that the system is so constituted that the setting operation can be conducted when the system manager logons the system with the password registered in advance. Further, it is also applicable that the system is so constituted that the storage section provided in either network 10 or network 20 stores the setting data with respect to the routing operation in advance, and image-processing apparatus 1 voluntarily accesses the storage section to acquire the setting data and sets them in itself.

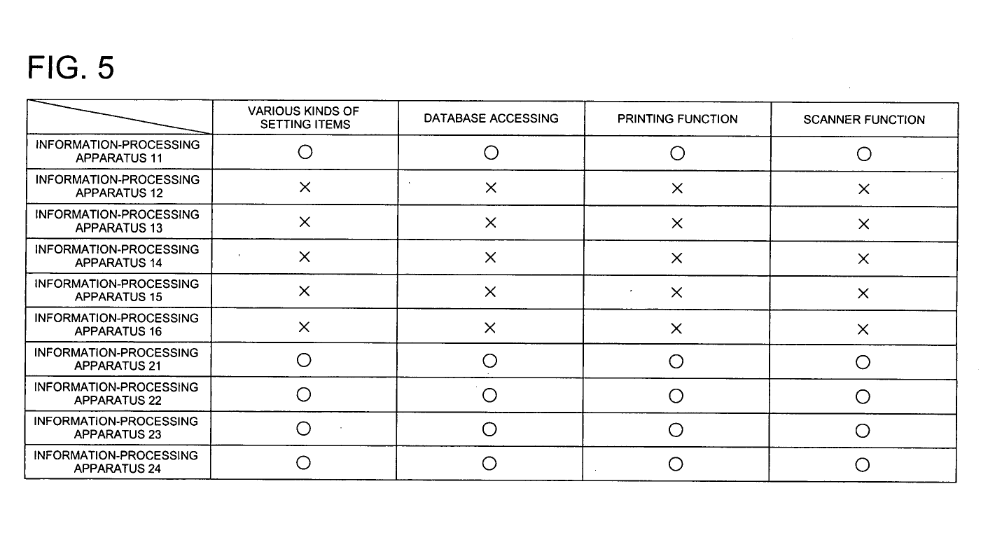

FIG. 5 shows an example of a setting table with respect to the functional restrictions in image-processing apparatus 1 shown in FIG. 1.

As the functional restrictions, the setting data, with respect to the accessing operation from each of the apparatus to storage section 38 and whether or not each of various functions provided in image-processing apparatus 1 is usable, can be registered. This is the provided function setting means.

According to the example shown in FIG. 5, it is possible for information-processing apparatus 11 to utilize all of the functions, it is impossible for information-processing apparatus 12-16 to utilize all of the functions, and it is possible for information-processing apparatus 21-24 to utilize all of the functions.

According to the functional restrictions in the setting table shown in FIG. 5 as an example, network I/F controlling section 34 determines whether or not the accessing operation from each of the apparatus to storage section 38 is allowed and whether or not each of various functions provided in image-processing apparatus 1 is usable.

Further, the image-processing system, embodied in the present invention, provides a function of a database server, in which, for instance, information-processing apparatus 21 stores the data, to be transmitted to information-processing apparatus 22-24, into storage section 38. At this time, if the setting tables, shown in FIG. 4 and FIG. 5, are effective, information-processing apparatus 22-24 can acquire the data stored in storage section 38, while information-processing apparatus 13-16 are rejected to acquire and store the data since the accessing operation to storage section 38 is not allowed.

Other than the embodiment shown in FIG. 1, the image-processing system, embodied in the present invention, can be implemented in various kinds of embodiments, several examples of which will be detailed in the following.

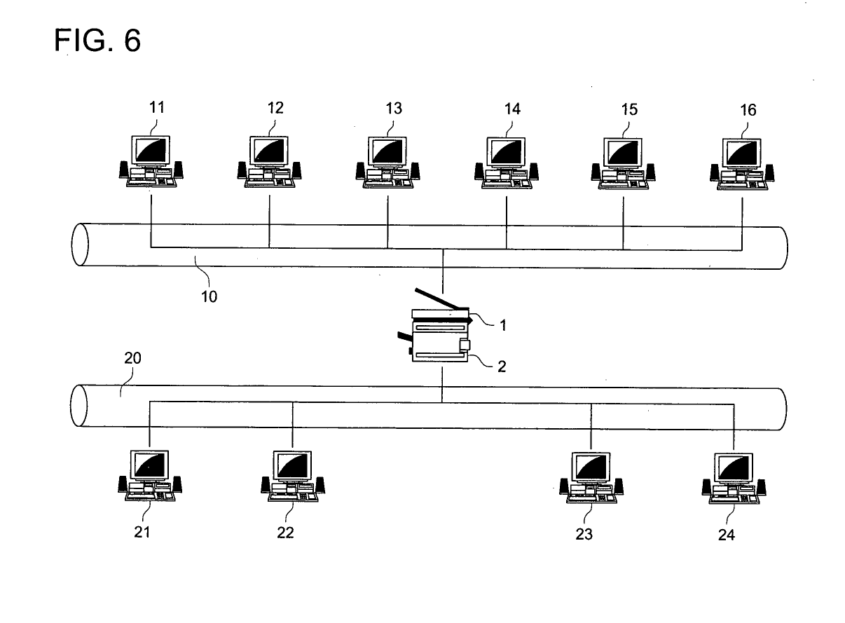

FIG. 6 shows a block diagram of a configuration of the image-processing system, as a second embodiment of the present invention.

As shown in FIG. 6, according to the second embodiment of the present invention, image-processing apparatus 1 and image-printing apparatus 2 are integrated into a single apparatus, which serves as an image-forming apparatus and through which network 10 is coupled to network 20. Even by employing the configuration of the second embodiment, the abovementioned features of the present invention can be attained as well.

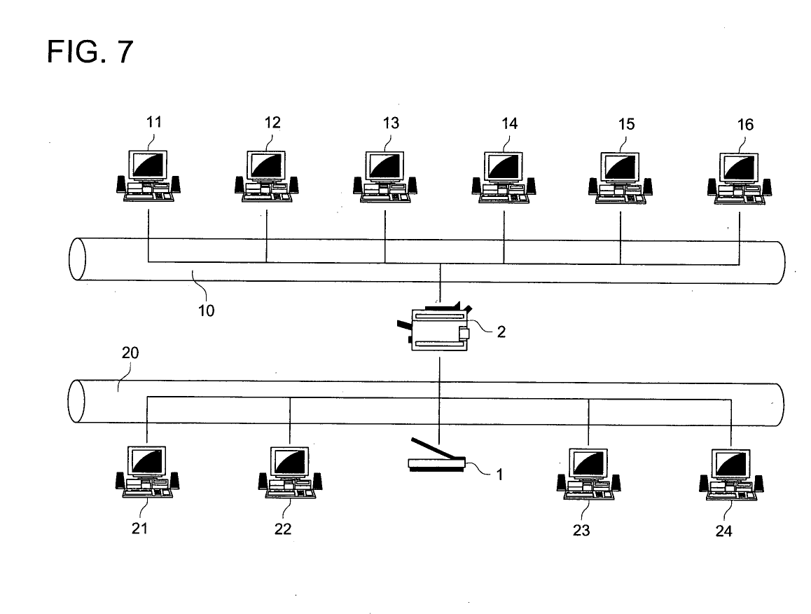

FIG. 7 shows a block diagram of a configuration of the image-processing system, as a third embodiment of the present invention.

As shown in FIG. 7, according to the third embodiment of the present invention, only image-processing apparatus 1 is coupled to network 20, while network 10 is coupled to network 20 through image-printing apparatus 2. Even by employing the configuration of the third embodiment, the abovementioned features of the present invention can be attained as well.

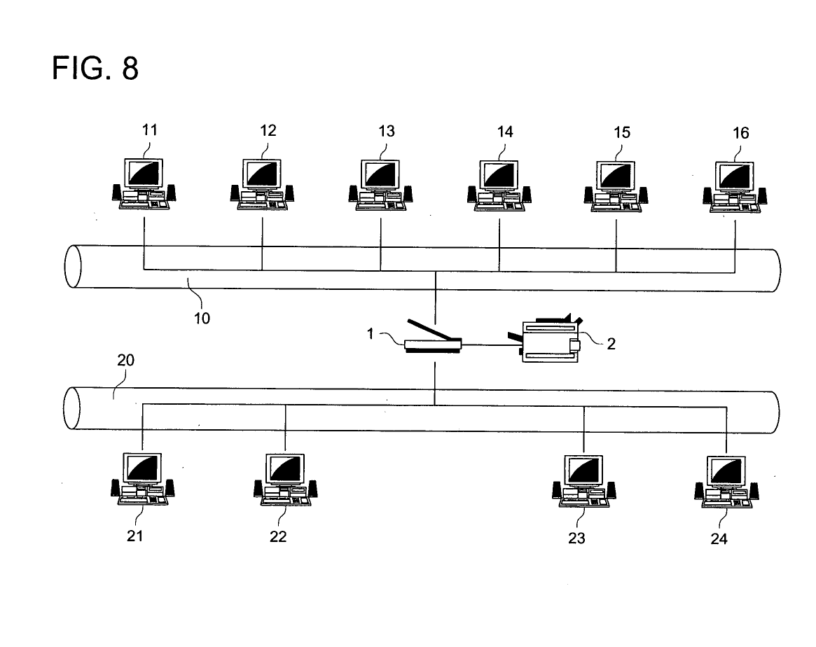

FIG. 8 shows a block diagram of a configuration of the image-processing system, as a fourth embodiment of the present invention.

As shown in FIG. 8, according to the fourth embodiment of the present invention, image-printing apparatus 2 is coupled to local connection I/F section 33 of image-processing apparatus 1. Even by employing the configuration of the fourth embodiment, the abovementioned features of the present invention can be attained as well.

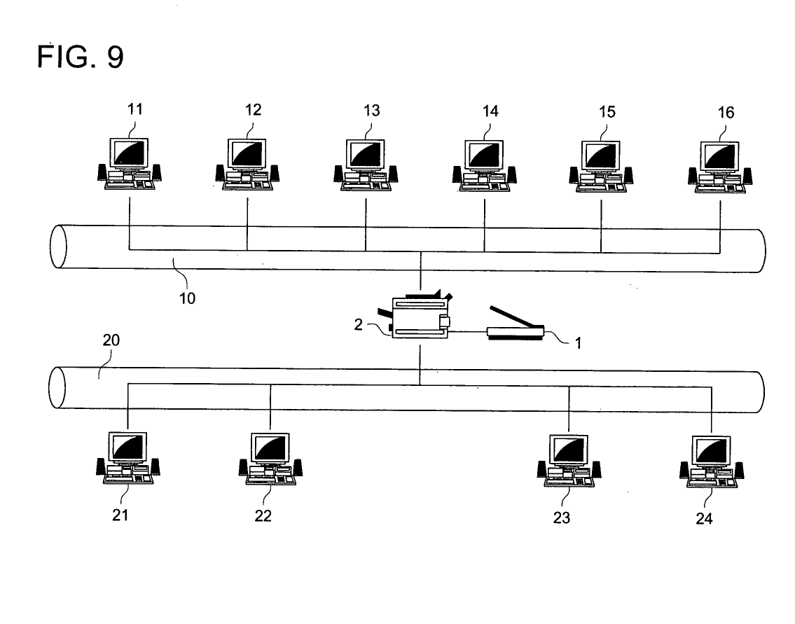

FIG. 9 shows a block diagram of a configuration of the image-processing system, as a fifth embodiment of the present invention.

As shown in FIG. 9, according to the fifth embodiment of the present invention, image-printing apparatus 2 is coupled to local connection I/F section 33 of image-processing apparatus 1, and network 10 is coupled to network 20 through image-printing apparatus 2. Even by employing the configuration of the fifth embodiment, the abovementioned features of the present invention can be attained as well.

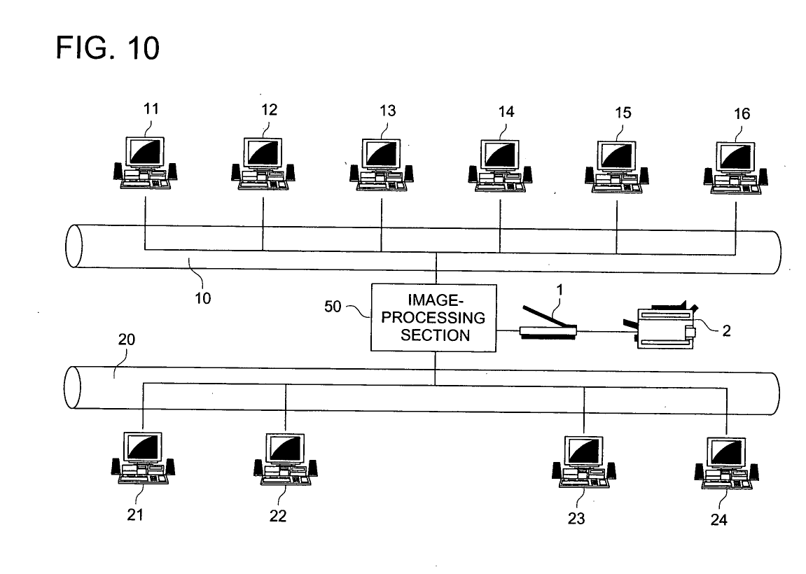

FIG. 10 shows a block diagram of a configuration of the image-processing system, as a sixth embodiment of the present invention.

As shown in FIG. 10, according to the sixth embodiment of the present invention, image-processing section 50 having the function of image-processing section 36 shown in FIG. 2 is newly introduced, and network 10 is coupled to network 20 through image-processing section 50. Further, image-processing apparatus 1 is coupled to image-processing section 50, and image-printing apparatus 2 is coupled to image-processing apparatus 1. Even by employing the configuration of the sixth embodiment, the abovementioned features of the present invention can be attained as well.

Further, in each of the abovementioned configurations, an inverse combination of the public network and private network is also applicable, and the network is not limited to the wired communication line.

Namely, the feature of the configuration, embodied in the present invention, can be attained regardless of a connecting mode employed in the image-processing system (provided with both the reading function, the printing function and the rasterizing function), and is that the image-processing system should include more than two networks. Just in this configuration, the abovementioned features of the present invention can be attained.

As described in the foregoing, according to the present invention, it becomes possible to provide an image-processing system, in which a security aspect between networks can be improved, while utilizing a network environment of coupling to a plurality of networks.

Further, according to the present invention, a private network environment can be constructed in a visitor room or a conference room, and the private network can be separated from the public network by the gateway function. In addition, it is possible to provide various kinds of server functions for the private network environment.

Incidentally, even in the closed environment, such as the visitor room or the conference room, the network and system equipments, such as a printer, a facsimile and a copier, which are coupled to the network, are required in order to efficiently perform business matters. Further, especially in such the closed environment, the environment separated from the public network should be created in a security point of view.

According to the present invention, by setting accessing restrictions for accessing operations from the apparatus, operated on the private network equipped in the visitor room, to the public network, it becomes possible to preserve the security in the premise concerned. In this case, it is assumed that an outsider would possibly enter the visitor room.

Further, by setting accessing restrictions for accessing operations from the apparatus operated on the public network to the private network equipped in the visitor room, it becomes possible to preserve the security in the visitor room. In this case, it is assumed that the security level should be high in the conference room.

Namely, the apparatus and systems embodied in the present invention have all of the abovementioned features, and of course, the features contribute the space saving and the source material saving trends, and further, it becomes possible for a system manager to provide services, which do not require complicated setting operations.

Further, by providing various kinds of server functions in the apparatus and systems, it becomes possible to further improve the efficiency of the business performance. For instance, by providing a database function, it becomes possible to easily construct a temporal common database. Accordingly, it becomes possible to improve the efficiency of the business performance even in the environment in which data transactions are conventionally conducted with detachable recording mediums, such as Floppy Disc, etc.

Disclosed embodiment can be varied by a skilled person without departing from the spirit and scope of the invention.

What is claimed is:

1. A network system for processing image data, comprising:
an image-processing apparatus including an image-reading section to read an image from a document;
an image-printing apparatus including an image-printing section to print an image on a sheet;
a plurality of networks including a first network and a second network; and
a plurality of information processing apparatus including a first information processing apparatus coupled to said first network and a second information processing apparatus coupled to said second network;
wherein said image-processing apparatus further includes:
a routing section to conduct a routing operation between said first information processing apparatus and said second information processing apparatus.

2. The network system of claim 1,
wherein said image-processing apparatus further includes:
a first network I/F section, through which said image-processing apparatus is coupled to said first network; and
a second network I/F section, through which said image-processing apparatus is coupled to said second network.

3. The network system of claim 1,
wherein said image-printing apparatus is coupled to either said image-processing apparatus or anyone of said plurality of networks.

4. The network system of claim 1,
wherein said image-processing apparatus and said image-printing apparatus are integrated into a single apparatus; and
wherein said single apparatus is coupled to both said first network and said second network.

5. The network system of claim 4,
wherein said single apparatus is a digital copier.

6. The network system of claim 1,
wherein said plurality of information processing apparatus includes a computer or a personal computer.

7. A network system for processing image data, comprising:
an image-processing apparatus including an image-reading section to read an image from a document;
an image-printing apparatus including an image-printing section to print an image on a sheet;
a plurality of networks including a first network and a second network; and
a plurality of information processing apparatus including a first information processing apparatus coupled to said first network and a second information processing apparatus coupled to said second network;
wherein said image-printing apparatus further includes:
a routing section to conduct a routing operation between said first information processing apparatus and said second information processing apparatus.

8. The network system of claim 7,
wherein said image-printing apparatus further includes:
a first network I/F section, through which said image-printing apparatus is coupled to said first network; and
a second network I/F section, through which said image-printing apparatus is coupled to said second network.

9. The network system of claim 7,
wherein said image-processing apparatus is coupled to either said image-printing apparatus or anyone of said plurality of networks.

10. The network system of claim 7,
wherein said image-processing apparatus and said image-printing apparatus are integrated into a single apparatus; and
wherein said single apparatus is coupled to both said first network and said second network.

11. The network system of claim 10,
wherein said single apparatus is a digital copier.

12. The network system of claim 7,
wherein said plurality of information processing apparatus includes a computer or a personal computer.

13. A network system for processing image data, comprising:
an image-processing apparatus including an image-reading section to read an image from a document;
an image-printing apparatus including an image-printing section to print an image on a sheet; and
an information processing apparatus coupled to both said image-processing apparatus and said image-printing apparatus through a network;
wherein said image-processing apparatus or said image-printing apparatus further includes:
a provided function setting section to set a functional restriction for restricting a function to be provided for said information processing apparatus.

14. The network system of claim 13,
wherein said image-processing apparatus and said image-printing apparatus are integrated into a single apparatus; and
wherein said single apparatus includes said provided function setting section.

15. The network system of claim 14,
wherein said single apparatus is a digital copier.

16. The network system of claim 13,
wherein said information processing apparatus is a computer or a personal computer.

17. A network system for processing image data, comprising:
an image-processing apparatus including an image-reading section to read an image from a document;
an image-printing apparatus including an image-printing section to print an image on a sheet; and
an information processing apparatus coupled to both said image-processing apparatus and said image-printing apparatus through a network;
wherein said image-processing apparatus or said image-printing apparatus further includes:
a server section that serves as a server for apparatus on said network.

18. The network system of claim 17,
wherein said image-processing apparatus and said image-printing apparatus are integrated into a single apparatus;
wherein said single apparatus is a digital copier including said server section.

19. The network system of claim 17,
wherein said information processing apparatus is a computer or a personal computer.

20. The network system of claim 17,
wherein said server section is anyone of a web server, a mail server and a database server.
